(19) United States
(12) Patent Application Publication
(10) Pub. No.: US 2020/0051026 A1
(43) Pub. Date: Feb. 13, 2020

(54) SYSTEM AND METHOD FOR CONVERSION OF MILITARY FLIGHT RECORDS TO CIVILIAN FLIGHT LOGBOOK

(71) Applicant: MilKEEP, LLC, Alexandria, VA (US)

(72) Inventors: Kimberly Uhland, Alexandria, VA (US); Christopher Uhland, Alexandria, VA (US)

(73) Assignee: MilKEEP, LLC., ALEXANDRIA, VA (US)

(21) Appl. No.: 15/837,745

(22) Filed: Dec. 11, 2017

Related U.S. Application Data
(60) Provisional application No. 62/432,601, filed on Dec. 11, 2016.

(51) Int. Cl. G06Q 10/10; G06Q 10/02; G06Q 10/06

(52) U.S. Cl. CPC G06Q 10/101; G06Q 10/06; G06Q 10/02

(57) ABSTRACT

This computer-based method generates an Electronic Civilian Logbook for military pilots. Individual users military flight record data is converted from standard military flight hour categories to categories defined in United States Government Code of Federal Regulations. This system allows the user to store personal flying records electronically in perpetuity.

### CROSS-REFERENCE TO RELATED APPLICATIONS

The present application is a non-provisional application that claims priority and incorporates by reference in its entirety U.S. Provisional Patent Application No. 62/432,601, entitled “System and Method for Conversion of Non-Digital Military Aviation Data to a Third-Party Commercial Digital Format” filed on Dec. 12, 2016. The Assignment of Ownership is attached hereto as Attachment 1; the Notice of Recordation of which is attached as Attachment 2.

### BACKGROUND OF THE INVENTION

### Field of the Invention

This invention relates to military and civilian aviation, more specifically electronic flight logbooks and the recordation and storage of individual flight data. The subject matter contained herein refers to the recordation and accounting of military flight data. Currently, no commercial digital system exists specifically for military pilots to track their personal flight records. Additionally, there is a significant difference between the method utilized by the military for tracking, classifying and summarizing these records and that of the civilian aviation industry. This invention aids military pilots in their transition to civilian aviation by quickly and easily gathering, converting and reclassifying their data.

### Description of the Related Art

This application claims the benefit of U.S. Provisional Application No. 62/432,601 filed Dec. 12, 2016; the disclosures of which are incorporated herein by reference and into this application in its entirety. The invention references Provisional Patent No. 62/432,601 as prior art to this application. The aforementioned prior art sets forth a system to first digitize non-digital military flight records. Secondly, the prior art established in Provisional Patent No. 62/432,601 establishes a method for converting these records to civilian means of classifying flight data records. The algorithm with which conversions are made is further described within the sections below.

### BRIEF SUMMARY OF THE INVENTION

The object of the invention is to simplify the process by which militant pilots classify and present their flight records. As stated previously, no commercial digital system exists specifically for military pilots to track their personal flight records. Additionally, there is a significant difference in the method utilized by the military for tracking, classifying and summarizing thesc records and that of the civilian aviation industry. This invention converts a user's military logbook to a civilian logbook using conversion algorithms further described herein. The resultant product has various applications and adheres to regulations mandated by the United States Government Code of Federal Regulations Title 14: Aeronautics and Space, PART 61—CERTIFICATION: PILOTS, FLIGHT INSTRUCTORS, AND GROUND INSTRUCTORS.

### BRIEF DESCRIPTION DRAWINGS

FIG. 1: FIG. 1 represents a Flow Chart Diagram Describing the Logbook Conversion Process.

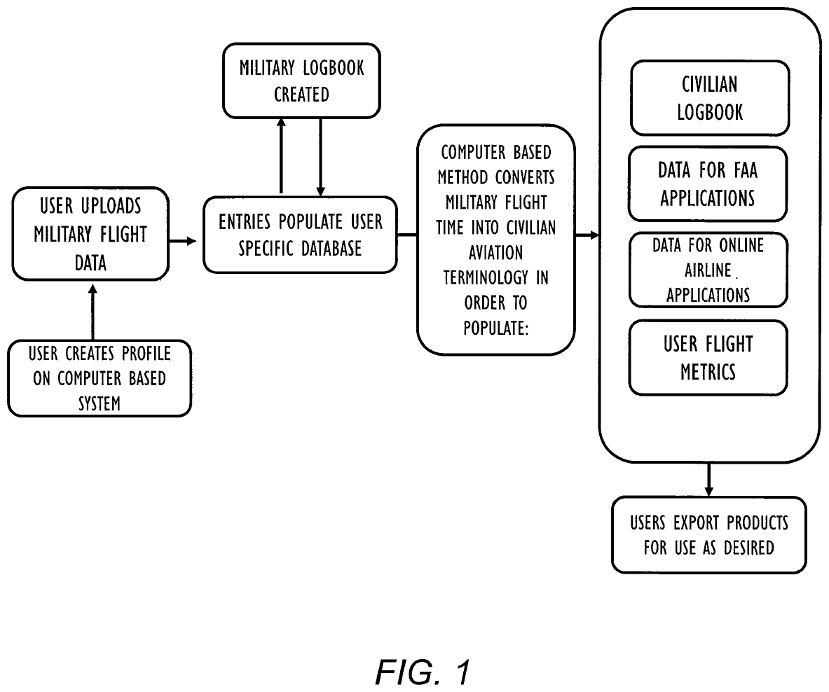

FIG. 2: FIG. 2 represents the logic employed by the invention's conversion algorithm in order to convert an Air Force user's military logbook to a civilian logbook.

FIG. 3: FIG. 3 represents the logic employed by the inventions conversion algorithm in order to convert a Navy or Marine Corps user's military logbook to a civilian logbook.

### DETAILED DESCRIPTION OF THE INVENTION

This application claims the benefit of U.S. Provisional Application No. 62/432,601 filed Dec. 12, 2016. The disclosures of which are incorporated herein by reference and into this application in its entirety.

This computer-based method begins with a user creating a unique profile and uploading military flight history data. The user's military flight history Bela populates a user specific database, creating a Military Logbook.

Users set preferences based on their specific branch of service and generally accepted civilian record keeping methods. These preferences define the algorithms used to convert military flight record history data into a civilian logbook which adheres to civilian aviation definitions found in United States Government Code of Federal Regulations, Title 14: Aeronautics and Space, PART 61—CERTIFICATION: PILOTS, FLIGHT INSTRUCTORS, AND GROUND INSTRUCTORS.

For Air Force Users:

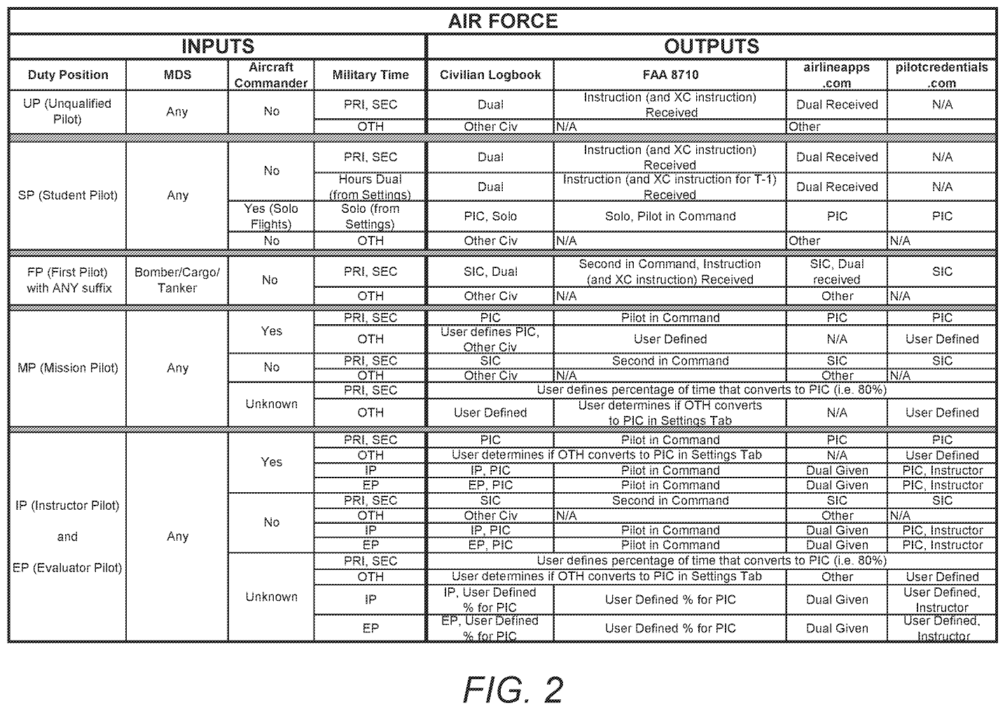

The invention uses logic displayed in FIG. 2 in order to convert military flight history data to a civilian logbook. The invention converts each user entry, known as a “sortie”, individually. Inputs for the algorithm include the Duty Position of the pilot, the Mission Design Series (type of aircraft), Aircraft Commander status, and flight time. Flight time includes PRI (Primary time), SEC (Secondary time), OTH (Other time), IP (Instructor Pilot time), and EP (Evaluator Pilot time).

Definitions of Duty Positions, Flight times and calculations are as follows:
a. FP_ (i.e. FPN, FPL, FPQ, etc.)=copilot. Process lists total Primary and Secondary time as “SIC”
b. MP=aircraft commander certified. Process asks user if they acted as the Aircraft Commander after data capture. If they select “yes”, Process will calculate total Primary and Secondary time as “PIC”. If user selects “no”, Process will calculate total Primary and Secondary time as “SIC”. If “Unknown”, process applies a percentage of time to “PIC” based on user preference.
c. IP=Instructor Pilot certified. Process asks user if they acted as the Aircraft Commander after data capture. If they select “yes”, Process will calculate total Primary and Secondary time as “PIC”. If user selects “no”, Process will calculate total Primary and Secondary time as “SIC”. If “Unknown”, process applies a percentage of time to “PIC” based on user preference.
d. EP=Evaluator Pilot certified. Process asks user if they acted as the Aircraft Commander after data capture. If they select “yes”, Process will calculate total Primary and Secondary time as “PIC”. If user selects “no”, Process will calculate total Primary and Secondary time as “SIC”. If “Unknown”, process applies a percentage of time to “PIC” based on user preference.
e. PRI=Process credits user with PIC or SIC time based on Duty Position logic rules above
f. SEC=Process credits user with PIC or SIC time based on Duty Position logic rules above
g. INST=Process credits user with “IP” time for time listed in this block
h. EVAL=Process credits user with “EP” time for time listed in this block
i. OTH=Time while not at primary controls of the aircraft. Process asks user if they acted as the Aircraft Commander after data capture. If user selects “yes”, Process credits user with “PIC” time for time listed in this block. If user selects “no”, Process credits user with “Other Civilian” time.
j. Total Time of the flight
k. SRT=total sorties flown
l. CMB=time logged while flying in a designated combat zone.
m. CMB SRT=total number of combat sorties flown
n. C/S=time logged while flying in a designated combat support role
o. C/S SRT=total number of combat support sorties flown
p. NITE=time logged during night hours
q. INS=time logged in instrument conditions
r. Sim INS=time logged in simulated instrument conditions
s. NVG=time logged while using Night Vision Goggles

Outputs are determined based on the inputs and user defined preferences. FIG. 2 is a reference tool that outlines how the invention converts inputs: beginning with Duty Position, trace along the applicable path from the left most column to determine the Output shown in the “Civilian Logbook” column. Outputs for the Civilian Logbook include Dual time, Other Civilian time, PIC (Pilot in Command time), SIC (Secondary in Command time), IP (Instructor Pilot time) and EP (Evaluator Pilot time).

For Navy/Marine Corps Users:

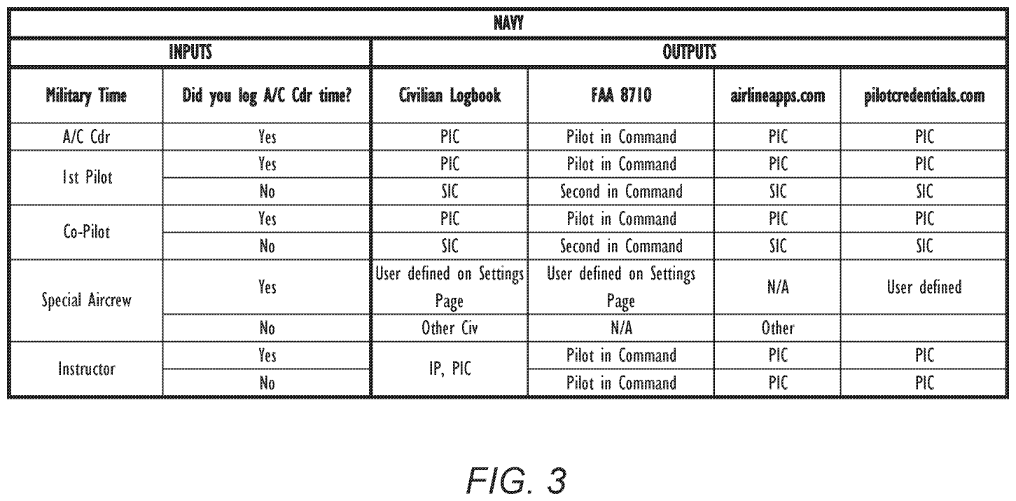

The invention uses logic displayed in FIG. 3 in order to convert military flight history data to a civilian logbook. The invention converts each user entry, known as a “sortie”, individually. Inputs for the algorithm include the Military Time of the pilot (A/C Cdr, 1^{st} Pilot, Co-Pilot, Special Aircrew, and Instructor). Outputs are determined based on the inputs and user defined preferences. FIG. 3 is a reference tool that outlines how the invention converts inputs: beginning with Military Time, trace along the applicable path from the left most column to the Output shown in the “Civilian Logbook” column. Outputs for the Civilian Logbook include Dual time, Other Civilian time, PIC (Pilot in Command time), SIC (Secondary in Command time), IP (Instructor Pilot time) and EP (Evaluator Pilot time).

User metrics from both the Military Logbook and Civilian Logbook are stored, tracked and presented to the user. This computer-based system allows military pilots to keep flight records electronically via a mode specifically designed for the military aviation community. It gives military pilots transitioning to the airline industry the capability to categorize and summarize their military flying hours that adhere to civilian aviation definitions found in United States Government Code of Federal Regulations, Title 14: Aeronautics and Space, PART 61—CERTIFICATION: PILOTS, FLIGHT INSTRUCTORS, AND GROUND INSTRUCTORS.

This system allows the user to store personal flying records electronically, in perpetuity, beyond the capability that the Department of Defense is able to maintain. Additionally, it allows military pilots to maintain an electronic Military Logbook while flying for the military.

The invention claimed is:

1. A computer-based method for generating a civilian flight logbook, the method comprising: converting military flight record data by way of generally accepted conversion methods and user specific preferences.

2. The method of claim 1, further comprising converting and recategorizing Flight Hours recorded by military pilots for military sorties to their equivalent civilian aviation values as defined in United States Government Code of Federal Regulations, Title 14: Aeronautics and Space, PART 61—CERTIFICATION: PILOTS, FLIGHT INSTRUCTORS, AND GROUND INSTRUCTORS.

3. A computer-based method to store individual military flight records in perpetuity.
